(19) United States
(12) Patent Application Publication
(10) Pub. No.: US 2004/0053810 A1
(43) Pub. Date: Mar. 18, 2004

(54) Liquid laundry compositions comprising silicone additives

(76) Inventors: Jo Anne Tully, Mahopac, NY (US); Shayne J. Landon, Carmel, NY (US); Emie Silvestre, Yonkers, NY (US)

Correspondence Address: CROMPTON CORPORATION, Benson Road, Middlebury, CT, 06749, US

(21) Appl. No.: 10/223,006

(22) Filed: Aug. 16, 2002

(51) Int. Cl. C11D 7/02

(52) U.S. Cl. 510/511

(57) ABSTRACT

Disclosed herein is a composition comprising

A) a liquid laundry product; and

B) a silicone additive selected from the group consisting of

1) an emulsion polymerized acrylated silicone polyethylene glycol modified polydimethylsiloxane;

2) an emulsion of a high molecular weight amino modified polydimethylsiloxane,

3) a linear aminopolyalkyleneoxide modified polydinethiylsiloxane;

4) a neutralized linear aminiopolyalkenioxide modified polydimethylsiloxanie;

5) a pendant polyalkyleneoxide modified polydimethiylsiloxane; and

6) a linear polyalkyleneoxide modified polydimethylsiloxane

### BACKGROUND OF THE INVENTION

1. Field of the Invention

The present invention relates to liquid laundry compositions comprising silicone additives. More particularly the present invention relates to the use of silicone additives in liquid laundry compositions to increase the whiteness of laundered fabrics, as well as to improve their ease of ironing, hydrophilicity, and softness.

2. Description of Related Art

It is known in the art to use quaternary dialkylimidazolines, and quaternary amidoamines to provide softening benefits to fabrics These materials primarily provide softening by depositing from the rinse solution and building up on the fabrics. This ultimately yields poor re-wettability, as well as discoloration of the fabrics.

It is also known in the art to use silicone gums, quaternized silicones, and silicone copolymers in conjunction with organic compounds for increased softness.

U.S. Pat. No. 3,992,332 discloses a liquid composition for treatment of fabrics having a silicone glycol copolymer of nonionic series, a phosphate derivative of anionic series, and a compatible liquid base. Other ingredients may include a detergent, emollient, color, perfume, thickeners, liquid softening agents and soil retardants.

U.S. Pat. No. 4,661,267 discloses rinse-added fabric softening compositions containing a fabric softening active system at least 10% of which consists of certain di(higher alkyl) cyclic amines, and relatively low concentrations of polymeric soil release agents, such as hydroxyether cellulosic polymers, copolymeric blocks of terephthalate and ethylene oxide or propylene oxide and cationic guar gums The system optionally contains an aqueous emulsion of a predominantly linear polydialkyl or alkyl, aryl siloxane in which the alkyl groups can have from one to five carbon atoms and may be wholly or partially fluorinated.

U.S. Pat. No. 4,818,421 discloses a fabric softening detergent composition that includes, as essential components thereof, nonionic detergent, builder for the nonionic detergent, fabric softening cationic compound and silicone glycol copolymer. The silicone glycol copolymer is one that has an HLB number in the range of 4 to 7, due to the presence in the molecule of a polyethoxy polypropoxy chain, and the copolymer is said to improve the fabric softening capability of the cationic compound. The nonionic detergent may be either a broad range ethoxylate or a narrow range ethoxylate (NRE) and the builder may be of a phosphate or non-phosphate type.

U.S. Pat. No. 4,983,316 discloses a dispersible silicone antifoam composition for providing controlled foaming liquid laundry detergent formulations wherein there is provided a non-aqueous emulsion of primary and secondary silicone antifoam agents, at least one nonionic silicone surfactant for emulsifying the primary and secondary antifoam agents in a solvent, a first organic surfactant dispersing agent for assisting in dispersing the emulsified primary and secondary antifoam agents in the liquid laundry detergent, and a second dispersing agent of a nonionic difunctional block-copolymer terminating in primary hydroxyl groups for further assisting in dispersing the emulsified primary and secondary antifoam agents in the liquid laundry detergent.

U.S. Pat. No. 4,986,922 discloses a fabric softener including a silicon compound having the formula [(R₃SiO)₂—SiR—(CH₂)ₐ]_{b}N⁺R′_{4-b} X⁻ wherein R is an alkyl radical having one to six carbon atoms, R′ is an alkyl or aryl radical having one to eighteen carbon atoms; X is chloride, bromide, iodide, nitrate, or RSO₄⁻; a is an integer having a value from one to ten; and b is an integer having a value of two or three.

U.S. Pat. No. 5,026,489 discloses a fabric softener including an alkanolamino functional silicone compound having the formula (R₃SiO)₂SiR—(CHR′)ₐN⁺ R′_{b} R″_{3-b} X⁻ wherein R is an alkyl radical having one to six carbon atoms; R′ is selected from the group consisting of hydrogen, alkyl and aryl radicals having one to eighteen carbon atoms; R″ is (CHR′)OH; X is chloride, bromide, iodide, nitrate, or RSO₄⁻; a is an integer having a value of one to ten; and b is an integer having a value of one or two.

U.S. Pat. No. 5,045,225 discloses an antifoam composition and laundry detergent formulation including it. The antifoam composition comprises a selected alkylaminosilicone, finely divided filler particles and a hydrocarbon carrier oil. Optional ingredients include oil/water surfactants and silicone oils. The alkylaminosilicone reduces the surface tension of the hydrocarbon oil and renders the formulation self-hydrophobing.

U.S. Pat. Nos. 5,057,240 and 5,091,105 disclose a liquid detergent having fabric softening properties and including an improved fabric softening agent. The fabric softening agent is a silicone fabric softening agent selected from the group consisting of a polyorganosiloxane which is free of reactive organic functional groups and having a viscosity in excess of about 5,000 centistokes measured at twenty-five degrees Centigrade; a polydiorganosiloxane gum having a viscosity of about two million centistokes, or a mixture of the said gum with either a low viscosity polydiorganosiloxane or with a volatile cyclic silicone such as octamethylcyclotetrasiloxane or decamethylcyclopentasiloxane. Certain emulsions of a highly branched and cross-linked silicone polymer may also be employed.

U.S. Pat. No. 5,545,342 discloses antistatic, fabric softening and soil release promoting compositions which comprise a nonionic detergent, a soil release promoting agent of the PET-POET type, and a certain type of silicone polymer (designated Type X or Silicone X). Such compositions very preferably also include cationic fabric softener (CFS), polyacrylate, silicone glycol copolymer (SGC), and builder for the nonionic detergent, with adjuvants being optional. Also disclosed are compositions that comprise only some of the mentioned components, and such compositions may be employed as wash cycle additives to improve the properties of detergent compositions and of softergent compositions. Processes for manufacturing and using the compositions are also disclosed

U.S. Pat. No. 5,723,426 discloses heavy duty liquid detergent compositions containing selected cationic detersive surfactants and emulsions of silicone and selected emulsifing surfactants. The silicone emulsions have an average particle size of from about 5 to about 500 microns and provide exceptional cleaning and softeninig benefits The detergent compositions are structured and are said to provide exceptional cleaning and softening benefits.

U.S. Pat. No. 5,759,208 discloses heavy duty liquid or granular detergent compositions containing emulsions of silicone and selected emulsifying surfactanits. The silicone emulsions preferably have an average particle size of from about 20 to about 300 microns and are said to provide exceptional cleaning and softening benefit.

U.S. Pat. No. 6,207,782 discloses emulsions and dispersions of polymers formed from acrylated hydrophilic polysiloxanes and their copolymers with acrylate/inethacrylate comonomers wherein the polymer is formed in a solvent via radically catalyzed polymerization. Such a polymer has utility in personal care applications, as well as textile finishes and coating formulations.

U.S. Pat. No 6,376,456 discloses the inclusion of one or more wrinkle reducing ingredients in a laundry fabric softening product The benefits are delivered to the laundered item either during the rinse step of the washing procedure or in the dryer. The need for further wrinkle reducing steps when the items are taken from the dryer or after hang drying are thereby reduced.

U.S Published Application No 20020049019 discloses methods for improving the brightness, durable press properties of fabric, and shrinkage resistance properties that comprise treating the fabric with an aqueous solution comprising formaldehyde, catalyst for crosslinking the formaldehyde with natural fibers in the fabric, and silicone elastomer or precursor thereof, and heating the treated fabric to react the formaldehyde with natural fibers in the fabric. It is said that cellulose fabric which has a crosslinked formaldehyde durable press treatment and has been subjected to laundering with a brightener-containing detergent exhibits enhanced brightness after the laundering and that cellulose fabrics having a crosslinked formaldehyde treatment exhibit enhanced brightness after home laundering.

U.S. application Ser. No. 09/854,583, filed May 15, 2001, discloses a composition that comprises non-hydrolyzable, block, non-(AB)ₙ type copolymers comprising units of the formula {XR²[(SiO(R¹)₂]ₓSi(R¹)₃R²X}, units of the formula {YO(CₐH₂ₐO)_{b}Y}, and linking groups —NR³—, wherein R¹ is alkyl, R² is a divalent organic moiety, X and Y are independently selected divalent organic groups formed by the ring opening of an epoxide, R³ is selected from the group consisting of alkyl, aryl, aralkyl, oxygen-containing alkyl, oxygen-containing aryl, and oxygen-containing aralkyl, a=2 to 4, b=2 to 100, and x=1 to 500

European Patent Application 0 273 775 A2 discloses protected additives for use in cleaning compositions such as liquid laundry detergents that comprise an optical brightener, bleach, photoactive bleach, perfume, blueing agent or dye dispersed in, or coated with, a hydrophobic substance such as silicone oil or a hydrocarbon, which is insoluble in concentrated liquid detergent, but which is disrupted under normal cleaning conditions.

European Patent Application 0 399 706 A2 discloses a method of treating fibrous materials that comprises applying as the sole amine containing organosilicon compound the reaction product of an organopolysiloxane having O_{(3-a/2)}SiXₐRNHR^{′} groups with one or more monoepoxides X denotes a monovalent C₁₋₈ hydrocarbon (group, R is an alkylene group, R^{′} is H or a group of the formula RZ, Z being NHX, NH₂, NHRNH₂ or NHRNHX. No more than 10% of all amine groups may be primary amine groups The composition is preferably applied as an emulsion. Fibers thus treated are said to be soft and to show less yellowing than those of the prior art.

European Patent Specification 0 583 5 12 B 1 discloses a detergent additive comprising a water-soluble or water dispersible detergent active compound characterized in that a mixture of the compound with a surfactant is absorbed into a porous hydrophobic material, the porous material being coated with a hydrophobic material.

European Patent Specification 0 697 23 1 B 1 discloses a method to process and recycle active chemical substances from concentrated laundry detergents, by reverse osmosis of wastewater from the laundry's wastewater, in laundries which work in combination with a thermal waste incinerator, characterized by the resulting wash concentrate being introduced to a spray dryer in periodical intervals, and dried through the use of thermal heat, the resulting active chemicals, as a valuable raw material, are reintroduced to the wash process

U.K Patent Application 2 230 787 A discloses aqueous compositions for the treatment of textiles that comprise water having dispersed therein (A) an organic cationic compound, (B) a polydiorganosiloxane which is preferably linear and provided in the form of an emulsion, and (C) from 0.2 to 1 part by weight per part of Component (A) of a quaternary ammonium silane of the general formula (iii) R³₃SiR⁴N⁺(R⁵)₃X⁻ in which each R³ is akyl, hydroxyl, alkoxy, alkoxyalkoxy or trimethylsiloxy, R⁴ is a divalent aliphatic hydrocarbon linking the silicon and nitrogen atoms, each R⁵ represents a monovalent hydrocarbon group, 1 or 2 groups R⁵ having an aliphatic chain composed of on average from 8 to 18 carbon atoms and 1 or 2 groups R⁵ having an aliphatic chain composed of not more than 5 carbon atoms and X⁻ represents a monovalent anion. The compositions are said to be useful as rinse cycle softeners giving also improved rewettability to treated textile fabrics.

Dzyadyga, I N et al., Tekst. Prom-st. (Moscow) (1978), (10), 59-62, disclose that the decrease in optical whitening effect of finished cotton fabrics upon repeated washing varied with the composition of the siloxane finish composition The optical effect of fabrics was evaluated from the intensity of photoluminescence, and the hydrophobic effect of the finishing agent from the water repellency and water absorption data. Shrinkage, creasing, and tensile stress were used as criteria for changes in dimensional stability and wear resistance of the fabrics. The best results were obtained with a composition containing Whitestone BV (11108-01-3) 0 5, 50% GKZh 94 siloxane emulsion 60 0, and ADE 3 (15180-47-9) 1.5 g/L. Tensile strength of fabrics decreased 5.5-27.5% upon treatment with siloxanes, upon repeated washing the strength decrease was 2 5-13 4 and 18 1% for fabrics containing and without finishing agent, respectively. The optical whitening effect changed faster upon finishing than the shrinkage and creasing effects

Dzyadyga, I. N. et al., Izv. Vyssh. Uchebn. Zaved., Tekhnol. Legk. Prom-stt. (1981), 24(6), 37-44, studied the effect of the combined treatment of a cotton summer dress fabric with Whitening Agent BV (I) (11108-01-3) and various creaseproofing agents on the degree and endurance of the fluorescent brightness obtained by luminescent spectrophotometry. Use of organosilicon (KE-43-22), together with Karbamol TsEM (II) (136-84-5) and polyethylene (9002-88-4) emulsion as creaseproofing agents gave max (to 62.0%) and min (to 96.3%) decreases in the integral luminescent intensity in comparison with I alone (100%). The KE-43-22 also reduced I fastness to light (luminescent, arc, and quartz lamps) and multiple launderings, whereas urea-based II and/or Etamon DS (5 1635-81-5)-containing compositions inhibited photocheinical degradation of I, but activated its washing out

Welch, C. M. el al., Textile Chemist and Colorist & American Dyestuff Reporter 1(3):55-60 (November 1999) modified citric acid finishes with additives that improve both the performance and whiteness imparted by this durable press (DP) reagent. The rate and extent of the improvement in whiteness of treated cotton depended on the additives used and whether or not a process rinse was applied Under the most favorable conditions, final whiteness index values were virtually identical to those of untreated fabric. Tartaric acid was used as a co-reactive additive at mole ratios of 1:1 and 1:2 with citric acid. Formation of a cellulose-reactive 1:1 alternating copolymer in situ in the cotton fibers may account for higher DP appearance ratings and increased wrinkle recovery angles imparted with the 1:1 mole ratio. Use of methyl hydrogen silicone as fabric softener in such mixed finishes led to higher DP performance, greater wrinkle resistance, and higher final whiteness index than did low density polyethylene.

The disclosures of the foregoing are incorporated herein by reference in their entirety.

### SUMMARY OF THE INVENTION

The present invention relates to the inclusion of a silicone additive in a liquid laundry product to impart increased whiteness, ease of ironing, hydrophilicity, and softness to the laundered article. The benefits are delivered to the laundered items either during the wash cycle or the rinse cycle of the wash procedure. The silicone additives improve the properties of detergent compositions and rinse cycle additives. Such additives render the fabric, especially 100% cotton twill and terry cloth, whiter and brighter than fabrics treated with liquid laundry compositions that do not contain these silicone additives. This increase in whiteness can be detected both visually and spectrophotometrically (reflectance) as measured by a Hunter Colorimeter In addition, fabrics treated with these silicone additives in liquid laundry compositions require less effort to iron, have an increased capacity for water absorbency, and are softer to the touch than do those treated with liquid laundry compositions that do not contain these additives

More particularly, the present invention is directed to a composition comprising:

A) a liquid laundry product; and

B) a silicone additive selected from the group consisting of

1) an emulsion polymerized acrylated silicone polyethylene glycol modified polydimethylsiloxane;

2) an emulsion of a high molecular weight amino modified polydimethiylsiloxane;

3) a linear aminopolyalkyleneoxide modified polydimethylsiloxane;

4) a neutralized linear aminiopolyalkenioxide modified polydimethylsiloxanie;

5) a pendant polyalkyleneoxide modified polydimethylsiloxane; and

6) a linear polyalkyleneoxide modified polydimethylsiloxane.

In another aspect, the present invention is directed to a method for laundering a textile fabric comprising washing said fabric in the presence of a composition comprising:

A) a liquid laundry product; and

B) a silicone additive selected from the group consisting of.

1) an emulsion polymerized acrylated silicone polyethylene glycol modified polydimethylsiloxane;

2) an emulsion of a high molecular weight amino modified polydimethylsiloxane,

3) a linear aminopolyalkyleneoxide modified polydimethiylsiloxane;

4) a neutralized linear aminiopolyalkenioxide modified polydimethylsiloxanie;

5) a pendant polyalkyleneoxide modified polydimethylsiloxane; and

6) a linear polyalkyleneoxide modified polydimethylsiloxane.

### DESCRIPTION OF THE PREFERRED EMBODIMENTS

The approach of the current invention comprises the addition of silicone additives to a liquid laundry product. These silicone additives restore the brightness of the laundered fabric, in particular 100% cotton twill and terry cloth, while at the same time reducing the work needed to iron the fabric Hydrophillicity and softness are also increased In accordance with the present invention, the performance of a liquid laundry product can be enhanced in a multitude of ways by the addition of at least one silicone additive. These silicone additives overcome a major drawback of rinse cycle softeners - discoloration of the fabric In addition, other performance advantages are also obtained allowing producers to introduce new and improved products.

The silicone additives are added to a commercially available (rinse cycle softener formulation or liquid laundry detergent) liquid laundry product and are dispensed to the wash or rinse liquor at an appropriate time through the action of a commercial domestic washing machine and dried under normal conditions through the use of a commercial domestic dryer. The inventors have found that when 100% cotton twill and terry cloth fabrics were evaluated under standardized conditions, the whiteness (as measured by reflectance) of these fabrics was dramatically increased as compared to a control fabric treated with a commercial liquid laundry detergent and commercial rinse cycle fabric softener. Furthermore, fabrics—100% cotton print, 100% cotton twill, and terry cloth—treated with said silicone additives were enhanced by an increased capacity for water absorbency (hydrophilicity), were easier to iron, and were softer than fabrics treated with commercial liquid laundry products without silicone additives.

Preferred silicone additives for use in the present invention include emulsion polymerized acrylated silicone polyethylene glycol modified polydimethylsiloxanes (hereinafter Silicone 1); emulsions of high molecular weight amino-modified polydimethylsiloxanes (hereinafter Silicone 2); linear aminopolyalkyleneoxide oxide-modified polydimethylsiloxanes (hereinafter Silicone 3); neutralized linear aminopolyalken oxide modified polydimethylsiloxanes (hereinafter Silicone 4), pendant polyalkylene oxide-modified polydimethylsiloxanes (hereinafter Silicones 5 and 6); and linear polyalkylene oxide-modified polydimethylsiloxanes (hereinafter Silicone 7)

More specifically

Silicone 1 is a commercially available product described in U.S. Pat. No. 6,207,782 by the general formula:

{(R¹⁰)₃SiO_{1/2}}ₘ{O_{1/2}Si(R¹⁰)₂)O_{1/2}}ₙ{SiO_{3/2}R¹⁰}ₒ{SiO_{4/2}}ₚ

wherein:

R¹⁰ is selected from R¹¹ and P,

each R¹¹, which can be the same of different, is a monovalent hydrocarbon group;

each P is R¹³{O(C_{b}H_{2b}O)ₐCOCR¹⁴═CH₂}_{c},

R¹³ is a polyvalent organic moiety;

c is a valency of R¹³−1;

R¹⁴ is hydrogen or methyl;

b is 2 to 4;

a is 1 to 1000;

m+n+p+o is equal to 1 to 100,

at least one R¹⁰ is P;

n is 1 to 100;

when o is not zero, n o is less than 10 1;

when p is not zero, n.p is less than 10:1, and

m is0 to 10.

Silicone 2 is a commercially available product described as the emulsion condensation reaction product of a silanol (hydroxyl terminated) fluid (R²⁰)Si(R⁵⁰)₂O[Si(R⁵⁰)₂O)]_{d}Si(R⁵⁰)₂R²⁰

wherein

R²⁰ is hydroxyl,

each R⁵⁰ is independently an alkyl radical of from 1 to 12, preferably 1 to 6, more preferably 1, carbon atoms, and

d is an integer of from 1 to 50, preferably 10 to 50, more preferably 20 to 50; and

an amino functional silane of the general structure:

(R²¹)₃₋ₐ(R²²)ₐSi—R²³—N(R²⁴)(R²⁵)

wherein:

R²² is an alkyl radical of from 1 to 12, preferably 1 to 6, more preferably 1, carbon atoms;

R²¹ is an alkoxy radical of from 1 to 6 carbon atoms, preferably methoxy,

R²³ is alkylene of from 1 to 10 carbon atoms, preferably 3 carbon atoms,

R²⁴ and R²⁵ are independently selected from the group consisting of hydrogen, alkyl, preferably C₁-C₆ alkyl, aryl, aralkyl, and amino alkyl; and

a is 0 or 1, preferably 1.

Aqueous amino functional silicone emulsions are known in the art See, for example, U.S. Pat. No 4,273,584, incorporated herein by reference in its entirety, which is directed to a detergent composition based on such an emulsion The emulsions are made by acid or base catalyzed aqueous emulsion polymerization of a polyorganosiloxane monomer in the presence of one or more emulsifiers and an amino functional silane.

Silicone 3 is a commercially available product, described in U.S. application Ser. No. 09/854,583, filed May 15, 2001, that is one of a group of non-hydrolyzable, block, non-(AB)ₙ type copolymers comprising units of the formula {XR³²[SiO(R³¹)₂]_{g}Si(R³¹)₂R³²X}, units of the formula {YO(C_{b}H_{2b}O)_{α}Y}, and linking groups, —NR³³—,

wherein

R³¹ is alkyl;

R³² is a divalent organic moiety,

X and Y are independently selected divalent organic groups formed by the ring opening of an epoxide;

R³³ is selected from the group consisting of alkyl, aryl, aralkyl, oxygen-containing alkyl, oxygen-containing aryl, and oxygen containing aralkyl;

b is 2 to 4;

α is 2 to 100, and

g is 1 to 500.

Silicone 4 is commercially available and is a composition as described above for Silicone 3 neutralized by a direct addition of a fatty acid, e.g., stearic acid

Silicone 5 (referred to herein as a “first pendant polyalkyleneoxide modified polydimethiylsiloxane”) is a commercially available siloxane polyether copolymer described by the general formula

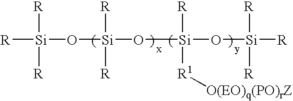

where

each R is independently a monovalent hydrocarbon group of from 1 to 12, preferably 1 to 6, more preferably 1 carbon atom(s),

R¹ is an alkylene group of from 1 to 10, preferably 3, carbon atoms,

EO is ethyleneoxy

PO is propyleneoxy;

x is 0-2, preferably 0;

y is 1-5, preferably 1 to 2;

q is 5-10, preferably 7 to 8;

r is 0-10, preferably 0; and

Z is a capping group that is either hydrogen or a monovalent carbon radical of from 1 to 12 carbon atoms, preferably methyl

Silicone 6 (referred to herein as a “second pendant polyalkyleneoxide modified polydimethylsiloxane”) is a commercially available product described by the same general formula as given above for Silicone 5, except

x is 10 to 100, preferably, 50 to 80;

y is 1 to 20, preferably, 5 to 10,

q is 5 to 40, preferably, 20 to 30, and

r is 2 to 50, preferably 20 to 40

Silicone 7 is a commercially available (AB)ₙ polymer of the general formula

—[—CₐH₂ₐ—(—Si(R⁷²)₂O—)—Si(R⁷²)₂—CₐH₂ₐ(OC₂H₄)ᵢ(OC₃H₆)ₙ—]ₙ—

wherein.

each R⁷² is independently a monovalent hydrocarbon group of from 1 to 12, preferably 1 to 6, more preferably 1, carbon atom(s),

a is 2 to 4, preferably 4,

i is 5 to 30, preferably 25;

h is 3 to 10, preferably 7, and

n is 1 to 2, preferably 1 5.

Non-hydrolyzable (AB)ₙ block copolymers of siloxane and organic ethers are well known in the art See, for example, U.S. Pat. No. 4,242,466, which outlines the preparation of (AB)ₙ copolymers useful for the stabilization of polyurethane foams.

The silicone copolymers employed in the practice of the present invention can be prepared by general methods that are well known to those skilled in the art For example, U.S. Pat. Nos. 3,280,160;3,299,112; and 3,507,815 report the synthesis of copolymers of this type and demonstrate their utility as polyurethane foam stabilizers, as additives for personal care items, and as processing aids for textile applications. The copolymers can be prepared from allyl polyethers and polydimethylhydridosiloxanes in the presence (U.S. Pat. Nos. 3,980,688 and 4,025,456) or absence (U.S. Pat. Nos. 4,847,398 and 5,191,103) of a solvent. The disclosures of the above mentioned patents are incorporated herein by reference in their entirety.

In the present invention, the desired silicone can be introduced to a liquid laundry product by blending the components of the product together in a conventional mixer. For example, the resultant blend can be mixed, e g, for about 20 minutes, using a laboratory Lightnin' mixer at about 750 rpm, then ultimately added to the washer.

The liquid laundry product used in the practice of the present invention is not particularly limited and can be prepared according to various methods known in the art. For example, U.S. Pat. No. 4,661,267 outlines the components and mode of manufacture of a representative laundry product.

As disclosed in that patent, the compositions contain a low level of soil release agent and a softener active system at least part of which is an amine of the formula:

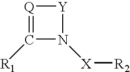

wherein Y is (CH₂)ₙ, n is 2 or 3; R₁ and R₂ are, independently, a C₈-C₃₀ alkyl or alkenyl or mixtures of such alkyl radicals. Examples of such mixtures are the alkyl radicals obtained from coconut oil, “soft” (non-hardened) tallow, and hardened tallow. Q is CH or N; X is

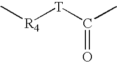

wherein T is O or NR₅, R₅ being H or C₁-C₄ alkyl, and R₄ is a divalent C₁-C₃ alkylene group or (C₂H₄O)ₘ, wherein m is a number of from 1 to 8, or X is R₄

The softener active system comprises from 1% to 50% of the total composition. At least 10% of the softener active system is a di (higher alkyl) cyclic amine selected from those of the above formula The entire softener active system may be comprised of such amines, but preferably the system contains from 10% to 90% of one or more conventional fabric softening agents For proper dispersion of the amine it is desirable (and, when no other softening agents are present, even necessary) to formulate these compositions in the pH range of from 2 to 6.5.

The amount of soil release agent is related to the amount of softener active system in the composition. It has been found that compositions containing from 3% to 20%, preferably from 5% to 15%, by weight of the fabric softening active system, of soil release agent are suitable

### A. The Softener Active System

As described hereinabove, the softener active system comprises (by weight of the active system) from 10% to 100% of a specified amine and from 0% to 90% of one or more conventional fabric softening compounds, such as quaternary ammonium salts and certain silicones.

(a) The Amine

The cyclic amines used in these compositions have been described above.

Specific examples of such amines are as follows:

1-tallowamidoethyl-2-tallowimidazoline,

1-(2-C₁₄-C₁₈-alkyl-amidoetilyl)-2-C₁₃-C₁₇-alkyl-4,5-dihydro-imidazoline,

1-stearylamidopropyl-2-stearylimidazoline,

1-tallowamidobutyl-2-tallowpiperidine, and

2-coconutaamidoomethyl-2-laurylpyrimidine

(b) Quaternary Ammonium Salt

The softener active system can further comprise a conventional di (higher alkyl) quaternary ammonium softening agent. By “higher alkyl” as used in the context of the quaternaly ammonium salts herein is meant alkyl groups having from 8 to 30 carbon atoms.

The quaternary ammonium salt preferably comprises from 10% to 50% of the softener active system

B. The Soil Release Agent

Useful polymeric soil release agents include cellulosic derivatives such as hydroxyether cellulosic polymers, copolyineric blocks of ethylene terephthialate and polyethylene oxide or polypropylene oxide terephthalate, and cationic guar gums, and the like

The cellulosic derivatives that are functional as soil release agents are commercially available and include hydroxyethers of cellulose and cationic cellulose ether derivatives Preferred cellulosic soil release agents include methyl cellulose; hydroxypropyl methylcellulose; hydroxybutyl methylcellulose; or a mixture thereof, said cellulosic polymer having a viscosity in aqueous solution at 20° C. of 15 to 75,000 centipoise.

A more preferred soil release agent is a copolymer having random blocks of ethylene terephthalate and polyethylene oxide (PEO) terephthialate. More specifically, these polymers comprise repeating units of ethylene terephthalate and PEO terephthalate in a mole ratio of ethylene terephthalate units to PEO terephithialate units of from about 25.75 to about 35:65, said PELO terephthialate units containing polyethylene oxide having molecular weights of from about 300 to about 2000. The molecular weight of this polymeric soil release agent is in the range of from about 25,000 to about 55,000.

Another preferred polymeric soil release agent is a crystallizable polyester with repeat units of ethylene terephthalate units containing 10-15% by weight of ethylene terephthalate units together with 90-80% by weight of polyoxyethylenie terephthalate units, derived from a polyoxyethylene glycol of average molecular weight 300-5,000, and the mole ratio of ethylene terephthalate units to polyoxyethylene terephthalate units in the crystallizable polymeric compound is between 2:1 and 6.1

C Optional Ingredients

(a) Brøsted Acid

The pH of the composition is important for proper dispersion of the amine. Moreover, a moderately acidic pH is important for hydrolytic stability of polyester-type soil release agents, therefore, the composition preferably comprises a Brønsted acid having a pKa value of 6 or less.

The amount of acid should be Such that the pH of the dispersion, after mixing, is in the range from 2 to 8, preferably not greater than 6 Typically, the amount of acid is from 1% to 30% by weight of the amine.

Examples of suitable acids include the inorganic mineral acids, carboxylic acids, in particular the low molecular weight (C₁-C₅) carboxylic acids, and alkylsulfonic acids.

Suitable inorganic acids include HCl, H₂SO₄, HNO₃ and H₃PO₄ Suitable organic acids include formic, acetic, methylsulfonic, and ethylsulfonic acids Preferred acids are hydrochloric, phosphoric, formic, and methylsulfonic acids.

(b) Organic Solvent

The compositions can be formulated without the use of any organic solvent. However, the presence of organic solvents (for example, low molecular weight, water miscible aliphatic alcohols,) does not harm the storage stability, the viscosity, or the softening performance of the compositions

Typically, the amine and the optional quaternary ammonium salt will be obtained from a supplier of bulk chemicals in solid form or as a solution in an organic solvent, e g, isopropanol There is no need to remove such a solvent in making the compositions of this invention. Indeed, additional solvent may be added, if this is deemed desirable.

(c) Optional Nonionics

The compositions optionally contain nonionlics for use in softener compositions Specific examples of nonionics suitable for the compositions include glycerol esters (e.g., glycerol monostearate), fatty alcohols (e.g , steaiyl alcohol), and alkoxylated fatty alcohols. The nonionic, if used, is typically used at a level in the range of from 0 5-10% by weight of the composition

Although generally considered as having fabric softening properties, the nonionics are not considered part of the fabric softening active system for the purposes of calculating the amount of fabric softening active system in the composition or of calculating the amount of soil release agent.

(d) Optional Silicone Component

The fabric softening active system optionally contains an aqueous emulsion of a predominantly linear polydialkyl or alkyl, aryl siloxane in which the alkyl groups can have from one to five carbon atoms and may be wholly or partially fluorinated Suitable silicones are polydimethyl siloxanes having a viscosity at 25° C. in the range from 100 to 100,000 centistokes, preferably in the range from 1000 to 12,000 centistokes

The optional silicone component embraces a silicone of cationic character which is defined as being one of:

(a) a predominantly linear di C₁-C₅ alkyl or C₁-alkyl, aryl siloxane, prepared by emuslion poyliymerizatioin using a cationic surfactant as emulsifier,

(b) an alpha-omega-di quaterized di(C₁-C₅) alkyl or C₁-C₅ alkyl, aryl siloxane polymer, or

(c) an amino-functional di C₁-C₅ alkyl or alkyl aryl siloxane polymer in which the amino group may be substituted and may be quaternized and in which the degree of substitution lies in the range 0 0001 to 0.1, preferably 0 01-0.075, provided that the viscosity at 25° C. of the silicone is from 100 to 100,000 cs

The fabric softeninig compositions may contain up to 10%, preferably from 0.1% to 5% of this silicone component

(e) Other Optional Ingredients

In order to further improve the stability of the compositions, and further adjust their viscosities, they can contain relatively small amounts of electrolyte. A highly preferred electrolyte is CaCl₂.

The compositions can also optionally contain other ingredients known to be suitable as softeners. Such adjuvents include perfumes, preservatives, germicides, colorants, dyes, fungicides, stabilizers, brighteners, and opacifiers. These adjuvents, if used, are normally added at their conventional levels

The components of the liquid laundry product can be mixed, stirred, or agitated. The composition of this invention can be made at any temperature or pressure variation, which can result in a liquid laundry product. The addition of the individual components is not limited to any particular order.

The amount of silicone additive employed in the composition of this invention is an amount that results in increased whiteness, ease of ironing, hydrophillicity, and/or softness in an article that has been laundered by the composition One or more of the silicones from the above identified classes are preferably included in known liquid laundry products in an amount from about 0 01 wt % to about 25 wt %, and more preferably, from 0.1 wt % to 5 wt %.

The present invention delivers these fabric enhancement properties in the wash and/or rinse cycle of the washing machine and is not padded on, heat cured, rubbed on, or delivered in conjunction with a durable press resin, nor do they provide cleaning The present invention also positively effects the whiteness value especially on 100% cotton twill and terry cloth.

The advantages and the important features of the present invention will be more apparent from the following examples

### EXAMPLES

In the following examples, the silicones employed are as follows.

Silicone 1 emulsion polymerized acrylated silicone polyethylene glycol modified polydimethylsiloxane,

Silicone 2: emulsion of a high molecular weight amino modified polydimethylsiloxane;

Silicone 3: linear aminopolyalkyleneoxide modified polydimethylsiloxane;

Silicone 4: neutralized linear aminiopolyalkenioxide modified polydimethylsiloxane;

Silicone 5: a first pendant polyalkyleneoxide modified polydimethiylsiloxane;

Silicone 6: a second pendant polyalkyleneoxide modified polydimethylsiloxane; and

Silicone 7: linear polyalkyleneoxide modified polydimethiylsiloxane.

### Preferred Method of Formula Preparation

The liquid laundry products were prepared as follows:

The silicone additives of Table 1 are incorporated into a liquid laundry product in an amount from 0 01 wt % to about 25 wt %, preferably about 0.01 wt % to about 15 wt %, more preferably from 0 1 wt % to about 5 wt %. The silicone additive and liquid laundry product are mixed together using a laboratory mixer at 800-1000 rpm, ring propeller, for approximately one half hour under ambient laboratory conditions The resultant product is a uniform free flowing liquid, which is dispensed following the manufacturer's recommended dosage to the wash or rinse liquor at the appropriate time through the action of a commercial domestic washing machine and dried under normal conditions using a commercial domestic dryer.

### Test Method and Examples

Bleached 100% cotton print, bleached 100% cotton twill, and bleached 100% cotton terrycloth were washed, dried, and stored in a well-defined way, using a top loading washing machine under cotton sturdy conditions and a dryer programmed for regular cycle.

### Reflectance

### Background

Improved brightness is evidenced by an increase in the reflectance of light from a fabric. Perfectly reflecting light measures 100 by all whiteness index equations. During the home laundering process, fabrics can often exhibit improved brightness from laundry detergents employed due to the accumulation of brighteners incorporated into the wash formulation However, many consumers then further treat washed garments during the last rinse cycle of the wash procedure with textile softening agents In general, the principal ingredient in these softening products is quaternary ammonium compounds, which deposit onto the fiber, but also tend to exhibit a yellowing effect on the fabric, and decrease its overall water absorbency capacity.

### Method

Treated fabrics were read for reflectance using a Hunter colorimneter, which was standardized as described by the manufacturer. The higher the numerical value, the whiter the fabric. The data reported are an average of 3 readings.

### Example 1

Using the test method described above, fabrics were laundered using a liquid laundry product (Tide) and one of the silicone additives post-added to a liquid laundry product (Downy) or the same formulation without any silicone post-added. (Tide and Downy are trademarks of The Proctor & Gamble Company.) Results of the testing after one and five wash/dry cycles show the reflectance benefits with the use of silicone additives of the present invention on cotton twill and are shown in Table 1.

TABLE 1
Reflectance Benefits on Cotton Twill

| | One wash/dry cycle | Five wash/dry cycles |
|---|---|---|
| Tide | 71.21 | 71.90 |
| Tide/Downy | 70.04 | 70.33 |
| Tide/Downy/Silicone 1 | 70.61 | 77.85 |
| Tide/Downy/Silicone 2 | 77.23 | 77.05 |
| Tide/Downy/Silicone 3 | 77.30 | 76.54 |
| Tide/Downy/Silicone 4 | 76.57 | 77.79 |
| Tide/Downy/Silicone 5 | 75.17 | 76.1 |
| Tide/Downy/Silicone 6 | 75.63 | 77.69 |
| Tide/Downy/Silicone 7 | 76.04 | 77.09 |

It can be seen from these results that silicones 2-7 after one wash/dry cycle yield treated fabrics that have higher whiteness indices than those of the fabric treated without the silicone ingredient It can also be seen from the results that the method of the present invention yields treated fabrics that have higher whiteness indices with all silicone treatments, 1-7, than those of the untreated farbics after five wash/dry cycles

### Example 2

Using the test method described above, fabrics were laundered using a liquid laundry product (Tide) and one of the silicone additives post-added to a liquid laundry product (Downy Enhancer) or the same formulation without any silicone post-added. Results of the testing after one and five wash/dry cycles show the reflectance benefits with the use of silicone additives of the present invention on cotton twill and terry cloth and are shown in Table 2.

TABLE 2
Reflectance Benefits on Cotton Twill and Cotton Terry Cloth

| | Cotton Twill | | Cotton Terry Cloth | |
|---|---|---|---|---|
| | One Time | Five Times | One Time | Five Times |
| Tide | 71.21 | 71.90 | 77.66 | 75.46 |
| Tide/Downy | 71.59 | 72.21 | 68.49 | 67.09 |
| Enhancer (T/DE) | | | | |
| T/DE/Silicone 1 | 73.62 | 74.97 | 75.51 | 67.03 |
| T/DE/Silicone 2 | 74.11 | 75.95 | 70.94 | 64.46 |
| T/DE/Silicone 3 | 74.14 | 76.52 | 78.13 | 78.1 |
| T/DE/Silicone 4 | 74.53 | 74.53 | 68.53 | 68.53 |
| T/DE/Silicone 5 | 73.79 | 75.67 | 76.66 | 75.99 |
| T/DE/Silicone 6 | 72.97 | 73.06 | 72.90 | 68.01 |
| T/DE/Silicone 7 | 73.36 | 75.56 | 76.83 | 73.7 |

It is evident from the results that silicones 1-7, after both one and five wash/dry cycles, yielded improved whiteness compared to the cotton twill fabric treated without the silicones. On cotton terry cloth, it is evident after one wash/dry cycle that silicones 3, 5, and 7 provide higher whiteness indices than is obtained when the fabric is not treated with such additives. After five wash/dry cycles on cotton terry cloth, silicones 3, 4, and 7 provide higher whiteness indices than is obtained when the fabric is not treated with such additives.

### Ease of Ironing

### Method

The Coefficient of Friction (COF) is a measure of the relative difficulty with which the surface of one material will slide over an adjoining surface. “Slip” is a term denoting lubricity of two surfaces sliding in contact with each other Therefore, low COF denotes high slip. The TMI Direct Drive Monitor (model 32-06-00) for slip and friction was used to evaluate the degree of friction between a 200 g aluminum sled heated to 150° C. and treated fabric specimens The values are an average of 4 readings with low numbers being indicative of high slip.

### Example 3

Using the test method described above, fabrics were laundered using a liquid laundry product (Tide) and one of the silicone additives post added to a liquid laundry product (Downy) or the same formulation without any silicone post added Results of the testing after one wash/dry cycle are provided in Table 3 and show the ease of ironing benefits with the use of the silicone additives of the present invention on cotton print and cotton twill, and are significant at the 95% confidence level.

TABLE 3
Ease of Ironing Benefits

| | Cotton Print | Cotton Twill |
|---|---|---|
| Tide | 0.223 | 0.204 |
| Tide/Downy | 0.210 | 0.186 |
| Tide/Downy/Silicone 1 | 0.148 | 0.161 |
| Tide/Downy/Silicone 2 | 0.156 | 0.176 |
| Tide/Downy/Silicone 3 | 0.162 | 0.156 |
| Tide/Downy/Silicone 4 | 0.151 | 0.188 |
| Tide/Downy/Silicone 5 | 0.195 | 0.169 |
| Tide/Downy/Silicone 6 | 0.192 | 0.149 |
| Tide/Downy/Silicone 7 | 0.154 | 0.171 |

The data in Table 3 generally show a significant and unexpected improvement in ironing benefits through the use of silicones in accordance with the present invention.

### Example 4

Using the test method described above, fabrics were laundered using a liquid laundry product (Tide) and one of the silicone additives post added to a liquid laundry product (Downy Enhancer) or the same formulation without any silicone post added. Results of the testing after one washday cycle are provided in Table 4 and show the ease of ironing benefits with the use of the silicone additives of the present invention on cotton print and cotton twill, and are significant at the 95% confidence level

TABLE 4
Ease of Ironing Benefits for Cotton Print

| | |
|---|---|
| Tide | 0.223 |
| Tide/Downy Enhancer | 0.202 |
| Tide/Downy Enhancer/Silicone 1 | 0.181 |
| Tide/Downy Enhancer/Silicone 2 | 0.180 |
| Tide/Downy Enhancer/Silicone 3 | 0.193 |
| Tide/Downy Enhancer/Silicone 4 | 0.181 |
| Tide/Downy Enhancer/Silicone 5 | 0.186 |
| Tide/Downy Enhancer/Silicone 6 | 0.196 |
| Tide/Downy Enhancer/Silicone 7 | 0.196 |

The data in Table 4 generally show a significant and unexpected improvement in ironing benefits through the use of silicones in accordance with the present invention.

### Hydrophilicity

### Method

The American Society for Testing Materials (ASTM) Method D 5237-92, Standard Guide for Evaluating Fabric Softeners, describes a preferred method for evaluating the water absorbency of treated fabrics Test strips of the treated fabric are positioned in an aqueous dye solution. The height of migration of the dye solution in a specified the is measured. The greater the migration of the dye solution up the fabric, the better the re-wet (absorbency) properties. The value is an average of 3 readings/fabric swatch

### Example 5

Using the test method described above, fabrics were laundered using a liquid laundry product (Tide) and one of the silicone additives post-added to a liquid laundry product (Downy or Downy Enhancer) or the same formulation without any silicone post-added. Results of the testing after one and five wash/dry cycles are provided in Table 5 and show the water absorbency benefits with the use of silicone additive of the present invention on cotton print and cotton twill.

TABLE 5
Water Absorbency Benefits on Cotton Print and Cotton Twill

| | Cotton Print | | Cotton Twill | |
|---|---|---|---|---|
| | One | Five | One | Five |
| | Time | Times | Time | Times |
| Tide | 6.2 | 7.0 | 7.6 | 9.0 |
| Tide/Downy | 4.9 | 3.6 | 4.3 | 4.4 |
| Tide/Downy/Silicone 1 | 3.9 | 3.4 | 6.4 | 4.3 |
| Tide/Downy/Silicone 2 | 3.4 | 4.5 | 3.5 | 5.5 |
| Tide/Downy/Silicone 3 | 3.8 | 4.3 | 4.7 | 4.1 |
| Tide/Downy/Silicone 4 | 4.9 | 5.6 | 5.4 | 5.4 |
| Tide/Downy/Silicone 5 | 4.9 | 4.4 | 3.9 | 3.9 |
| Tide/Downy/Silicone 6 | 4.0 | 3.7 | 4.1 | 4.5 |
| Tide/Downy/Silicone 7 | 3.5 | 4 | 4.9 | 6.4 |
| Tide/Downy Enhancer (T/DE) | 4.5 | 4.4 | 4.9 | 4.8 |
| T/DE/Silicone 1 | 3.6 | 4.3 | 7.4 | 6.2 |
| T/DE/Silicone 2 | 5 | 5 | 6.4 | 5.3 |
| T/DE/Silicone 3 | 5.8 | 5.8 | 8.2 | 5.4 |
| T/DE/Silicone 4 | 4.4 | 4.7 | 7 | 6.2 |
| T/DE/Silicone 5 | 5.5 | 6.1 | 7 | 7.1 |
| T/DE/Silicone 6 | 5.1 | 5.6 | 6.2 | 6.4 |
| T/DE/Silicone 7 | 4.8 | 5 | 8.3 | 5.4 |

As is apparent from the data, fabric substrates treated with Silicones 1, 3, 4, 5, or 7 exhibited substantially increased water absorbency as opposed to the untreated fabric substrates

### Example 6

Using the test method described above, fabrics were laundered using a liquid laundry product (Tide) and one of the silicone additives post-added to a liquid laundry product (Downy Enhancer) or the same formulation without any silicone post-added. Results of the testing after one and five wash/dry cycles are provided in Table 6 and show the water absorbency benefits with the use of silicone additive of the present invention on cotton terry cloth.

TABLE 6
Water Absorbency Benefits on Cotton Terry Cloth

| | One Time | Five Times |
|---|---|---|
| Tide | 5.5 | 5.82 |
| Tide/Downy Enhancer | 4.6 | 4.3 |
| Tide/Downy Enhancer/Silicone 1 | 4.1 | 3.5 |
| Tide/Downy Enhancer/Silicone 2 | 4.2 | 3 |
| Tide/Downy Enhancer/Silicone 3 | 5.2 | 4 |
| Tide/Downy Enhancer/Silicone 4 | 4.1 | 4.1 |
| Tide/Downy Enhancer/Silicone 5 | 5.5 | 5 |
| Tide/Downy Enhancer/Silicone 6 | 4.4 | 4.5 |
| Tide/Downy Enhancer/Silicone 7 | 4.5 | 4 |

As is apparent from the data, fabric substrates treated with Silicone 5 exhibited increased capacity for water absorbency as opposed to untreated fabric

### Softness

### Method

The ASTM Method D 5237-92 describes a preferred method for evaluating the softness of treated fabrics. Softness is a subjective procedure where fabrics are ranked by panelists on a five point scale (least soft=1, softest=5), and for the purpose of this evaluation the term “softness” is characterized as the opposite of harshness, rather than fullness or compression. The fabrics treated with the silicone additives of the present invention are evaluated for softness by comparison with fabrics treated with the same softener formulation (Downy, Downy Enhancer) without silicone post-added The scores are totaled and averaged to give a single rating number for each treatment product.

### Example 7

Using the test method described above, fabrics were laundered using a liquid laundry product (Tide) and one of the silicone additives post-added to a liquid laundry product (Downy) or the same formulation without any silicone post added. Results of the testing after one and five wash/dry cycles are provided in Table 7 and show the softness benefits with the use of silicone additive of the present invention on cotton print

TABLE 7
Softness Benefits on Cotton Print

| | One wash/dry cycle | Five wash/dry cycles |
|---|---|---|
| Tide | 1.0 | 1.0 |
| Tide/Downy | 1.4 | 2.9 |
| Tide/Downy/Silicone 1 | 3.3 | 2.7 |
| Tide/Downy/Silicone 2 | 3.3 | 3.9 |
| Tide/Downy/Silicone 3 | 3.4 | 4.1 |
| Tide/Downy/Silicone 4 | 3.3 | 3.9 |
| Tide/Downy/Silicone 5 | 3.9 | 2.7 |
| Tide/Downy/Silicone 6 | 3.1 | 3.1 |
| Tide/Downy/Silicone 7 | 2.6 | 3.3 |

As is apparent from the data, fabric substrates treated with Silicones 1-7 exhibited comparable or improved softness as opposed to untreated fabric after one and five wash/dry cycles.

### Example 8

Using the test method described above, fabrics were laundered using a liquid laundry product (Tide) and one of the silicone additives post-added to a liquid laundry product (Downy Enhancer) or the same formulation without any silicone post-added Results of the testing after one and five wash/dry cycles are provided in Table 8 and show the softness benefits with the use of the silicone additives of the present invention on cotton print and cotton terry cloth

TABLE 8
Softness Benefits on Cotton Print and Cotton Terry Cloth

| | Cotton Print | | Cotton Terry Cloth | |
|---|---|---|---|---|
| | One Time | Five Times | One Time | Five Times |
| Tide | 1.0 | 1.0 | 1.0 | 1.0 |
| Tide/Downy | 3.8 | 2.5 | 2.3 | 2.5 |
| Enhancer (T/DE) | | | | |
| T/DE/Silicone 1 | 3.3 | 4 | 3.8 | 4.5 |
| T/DE/Silicone 2 | 3.3 | 4.5 | 4 | 3.8 |
| T/DE/Silicone 3 | 2.8 | 2.3 | 2.5 | 2.8 |
| T/DE/Silicone 4 | 3 | 2.5 | 2.8 | 4 |
| T/DE/Silicone 6 | 3.5 | 4.3 | 3 | 4.3 |
| T/DE/Silicone 7 | 4 | 4.5 | 4.8 | 3.5 |

In view of the many changes and modifications that can be made without departing from principles underlying the invention, reference should be made to the appended claims for an understanding of the scope of the protection to be afforded the invention.

What is claimed is

1. A composition comprising:
A) a liquid laundry product; and
B) a silicone additive selected from the group consisting of:
1) an emulsion polymerized acrylated silicone polyethylene glycol modified polydimethylsiloxanie,
2) an emulsion of a high molecular weight amino modified polydimethylsiloxanie,
3) a linear aminopolyalkyleneoxide modified polydimethylsiloxane;
4) a neutralized linear aminiopolyalkenioxide modified polydimethylsiloxane,
5) a pendant polyalkyleneoxide modified polydimethylsiloxane, and
6) a linear polyalkyleneoxide modified polydimethylsiloxanie.

2. The composition of claim 1 wherein the silicone additive is an emulsion polymerized acrylated silicone polyethylene glycol modified polydimethylsiloxane.

3. The composition of claim 2 wherein the silicone additive is of the general formula:
{(R¹⁰)₃SiO_{1/2}}ₘ{O_{1/2}Si(R¹⁰)₂)O_{1/2}}ₙ{SiO_{3/2}R¹⁰}ₒ{SiO_{4/2}}ₚ
wherein
R¹⁰ is selected from R¹¹ and P;
each R¹¹, which can be the same of different, is a monovalent hydrocarbon group;
each P is R¹³{O(C_{b}H_{2b}O)ₐCOCR¹⁴═CH₂}_{c},
R¹³ is a polyvalent organic moiety;
c is a valency of R¹³−1,
R¹⁴ is hydrogen or methyl;
b is 2 to 4;
a is 1 to 1000;
m+n+p+o is equal to 1 to 100;
at least one R¹⁰ is P;
n is 1 to 100;
when o is not zero, n.o is less than 10 1;
when p is not zero, n.p is less than 10 1; and
m is 0 to 10

4. The composition of claim 1 wherein the silicone additive is an emulsion of a high molecular weight amino modified polydimethylsiloxanie

5. The composition of claim 4 wherein the silicone additive is the emulsion condensation reaction product of a silanol (hydroxyl terminated) fluid (R²⁰)Si(R⁵⁰)₂O[Si(R⁵⁰)₂O)]_{d}Si(R⁵⁰)₂R²⁰ wherein:
R²⁰ is hydroxyl;
each R⁵⁰ is independently an alkyl radical of from 1 to 12 carbon atoms, and
d is an integer of from 1 to 50, and
an amino functional silane of tile general structure:
(R²¹)₃₋ₐ(R²²)ₐSi—R²³—N(R²⁴)(R²⁵)
wherein:
R²² is an alkyl radical of from 1 to 12 carbon atoms;
R²¹ is an alkoxy radical of from 1 to 6 carbon atoms,
R²³ is alkylene of from 1 to 10 carbon atoms,
R²⁴ and R²⁵ are independently selected from the group consisting of hydrogen, alkyl, preferably C₁-C₆ alkyl, aryl, aralkyl, and amino alkyl, and
a is 0 or 1

6. The composition of claim 1 wherein the silicone additive is a linear aminopolyalkyleneoxide modified polydimethiylsiloxane

7. The composition of claim 6 wherein the silicone additive is selected from the group consisting of non-hydrolyzable, block, non-(AB)ₙ type copolymers comprising units of the formula {XR³²[SiO(R³¹)₂]_{g}Si(R³¹)₂R³²X}, units of the formula {YO(C_{b}H_{2b}O)_{α}Y}, and linking groups, —NR³³—, wherein:
R³¹ is alkyl;
R³² is a divalent organic moiety,
X and Y are independently selected divalent organic groups formed by the ring opening of an epoxide;
R³³ is selected from the group consisting of alkyl, aryl, aralkyl, oxygen-containing alkyl, oxygen-containing aryl, and oxygen containing aralkyl;
b is 2 to 4,
α is 2 to 100, and
g is 1 to 500.

8 The composition of claim 1 wherein the silicone additive is a neutralized linear aminiopolyalkenioxide modified polydimethylsiloxane.

9. The composition of claim 8 wherein the silicone additive is selected from the group consisting of fatty acid neutralized non-hydrolyzable, block, non-(AB)ₙ type copolymers comprising units of the formula {XR³²[SiO(R³¹)₂]_{g}Si(R³¹)₂R³²X}, units of the formula {YO(C_{b}H_{2b}O)_{α}Y}, and linking groups, —NR³³—,
wherein:
R³¹ is alkyl,
R³² is a divalent organic moiety;
X and Y are independently selected divalent organic groups formed by the ring opening of an epoxide,
R³³ is selected from the group consisting of alkyl, aryl, aralkyl, oxygen-containing alkyl, oxygen-containing aryl, and oxygen containing aralkyl;
b is 2 to 4,
α is 2 to 100, and
g is 1 to 500.

10. The composition of claim 9 wherein the fatty acid is stearic acid.

11. The composition of claim 1 wherein the silicone additive is a pendant polyalkyleneoxide modified polydimethylsiloxane

12. The composition of claim 11 wherein the silicone additive is of the formula: 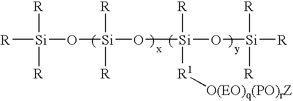
where:
each R is independently a monovalent hydrocarbon group of from 1 to 12 carbon atom(s);
R¹ is an alkylene group of from 1 to 10 carbon atoms,
EO is ethyleneoxy;
PO is propyleneoxy;
x is 0-2;
y is 1-5;
q is 5-10,
r is 0-10; and
Z is a capping group that is either hydrogen or a monovalent carbon radical of from 1 to 12 carbon atoms

13. The composition of claim 11 wherein the silicone additive is of the formula: 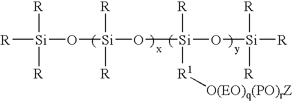
where:
each R is independently a monovalent hydrocarbon group of from 1 to 12 carbon atoms,
R¹ is an alkylene group of from 1 to 10 carbon atoms;
EO is ethyleneoxy;
PO is propyleneoxy;
x is 10 to 100,
y is 1 to 20;
q is 5 to 40;
r is 2 to 50, and
Z is a capping group that is either hydrogen or a monovalent carbon radical of from 1 to 12 carbon atoms.

14. The composition of claim 1 wherein the silicone additive is a linear polyalkyleneoxide modified polydimethylsiloxane

15 The composition of claim 14 wherein the silicone additive is an (AB)ₙ polymer of the general formula:
—[—CₐH₂ₐ—(—Si(R⁷²)₂O—)—Si(R⁷²)₂—CₐH₂ₐ(OC₂H₄)ᵢ(OC₃H₆)ₕ—]ₙ—
wherein:
each R⁷² is independently a monovalent hydrocarbon group of from 1 to 12 carbon atoms;
a is 2 to 4;
i is 5 to 30;
h is 3 to 10, and
n is 1 to 2.

16. A method for laundering a textile fabric comprising washing said fabric in the presence of a composition comprising
A) a liquid laundry product, and
B) a silicone additive selected from the group consisting of:
1) an emulsion polymerized acrylated silicone polyethylene glycol modified polydimethylsiloxane;
2) an emulsion of a high molecular weight amino modified polydimethylsiloxane,
3) a linear aminopolyalkyleneoxide modified polydimethylsiloxane;
4) a neutralized linear aminiopolyalkenioxide modified polydimethylsiloxanie;
5) a pendant polyalkyleneoxide modified polydimethylsiloxane, and
6) a linear polyalkyleneoxide modified polydimethylsiloxane.

17. The method of claim 16 wherein the silicone additive is an emulsion polymerized acrylated silicone polyethylene glycol modified polydimethiylsiloxane

18. The method of claim 17 wherein the silicone additive is of the general formula:
{(R¹⁰)₃SiO_{1/2}}ₘ{O_{1/2}Si(R¹⁰)₂)O_{1/2}}ₙ{SiO_{3/2}R¹⁰}ₒ{SiO_{4/2}}ₚ
wherein:
R¹⁰ is selected from R¹¹ and P;
each R¹¹, which can be the same of different, is a monovalent hydrocarbon group;
each P is R¹³{O(C_{b}H_{2b}O)ₐCOCR¹⁴═CH₂}ₒ,
R¹³ is a polyvalent organic moiety,
c is a valency of R¹³−1,
R¹⁴ is hydrogen or methyl,
b is 2 to 4,
a is 1 to 1000;
m+n+p+o is equal to 1 to 100,
at least one R¹⁰ is P;
n is 1 to 100,
when o is not zero, n o is less than 10 1;
when p is not zero, n p is less than 10 1, and
m is 0 to 10.

19. The method of claim 16 wherein the silicone additive is an emulsion of a high molecular weight amino modified polydimethylsiloxanie.

20. The method of claim 19 wherein the silicone additive is the emulsion condensation reaction product of a silanol (hydroxyl terminated) fluid (R²⁰)Si(R⁵⁰)₂O[Si(R⁵⁰)₂O)]_{d}Si(R⁵⁰)₂R²⁰
wherein:
R²⁰ is hydroxyl;
each R⁵⁰ is independently an alkyl radical of from 1 to 12 carbon atoms; and
d is an integer of from 1 to 50; and
an amino functional silane of the general structure
(R²¹)₃₋ₐ(R²²)ₐSi—R²³—N(R²⁴)(R²⁵)
wherein
R²² is an alkyl radical of from 1 to 12 carbon atoms,
R²¹ is an alkoxy radical of from 1 to 6 carbon atoms,
R²³ is alkylene of from 1 to 10 carbon atoms,
R²⁴ and R²⁵ are independently selected from the group consisting of hydrogen, alkyl, preferably C₁-C₆ alkyl, aryl, aralkyl, and amino alkyl, and
a is 0 or 1

21. The method of claim 16 wherein the silicone additive is a linear aminopolyalkyleneoxide modified polydimethylsiloxane.

22 The method of claim 21 wherein the silicone additive is selected from the group consisting of non-hydrolyzable, block, non-(AB)ₙ type copolymers comprising units of the formula {XR³²[SiO(R³¹)₂]_{g}Si(R³¹)₂R³²X}, units of the formula {YO(C_{b}H_{2b}O)_{α}Y}, and linking groups, —NR³³—,
wherein:
R³¹ is alkyl;
R³² is a divalent organic moiety;
X and Y are independently selected divalent organic groups formed by the ring opening of an epoxide;
R³³ is selected from the group consisting of alkyl, aryl, aralkyl, oxygen-containing alkyl, oxygen-containing aryl, and oxygen containing aralkyl;
b is 2 to 4,
α is 2 to 100; and
g is 1 to 500.

23. The method of claim 16 wherein the silicone additive is a neutralized linear aminopolyalkyleneoxide modified polydimethiylsiloxane

24 The method of claim 23 wherein the silicone additive is selected from the group consisting of fatty acid neutralized non-hydrolyzable, block, non-(AB)ₙ type copolymers comprising units of the formula {XR³²[SiO(R³¹)₂]_{g}Si(R³¹)₂R³²X)}, units of the formula {YO(C_{b}H_{2b}O)_{α}Y}, and linking groups, —NR³³—,
wherein:
R³¹ is alkyl,
R³² is a divalent organic moiety,
X and Y are independently selected divalent organic groups formed by the ring opening of an epoxide;
R³³ is selected from the group consisting of alkyl, aryl, aralkyl, oxygen-containing alkyl, oxygen-containing aryl, and oxygen containing aralkyl;
b is 2 to 4,
α is 2 to 100; and
g is 1 to 500.

25. The method of claim 24 wherein the fatty acid is stearic acid

26. The method of claim 16 wherein the silicone additive is a pendant polyalkyleneoxide modified polydimethylsiloxanie

27. The method of claim 26 wherein the silicone additive is of the formula. 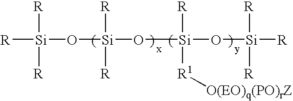
where
each R is independently a monovalent hydrocarbon group of from 1 to 12 carbon atom(s),
R¹ is an alkylene group of from 1 to 10 carbon atoms,
EO is ethyleneoxy,
PO is propyleneoxy;
x is 0-2;
y is 1-5;
r is 0-10, and
Z is a capping group that is either hydrogen or a monovalent carbon radical of from 1 to 12 carbon atoms

28. The method of claim 26 wherein the silicone additive is of the formula: 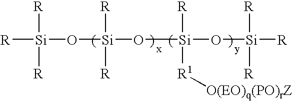
where
each R is independently a monovalent hydrocarbon group of from 1 to 12 carbon atoms,
R¹ is an alkylene group of from 1 to 10 carbon atoms;
EO is ethyleneoxy,
PO is propyleneoxy;
x is 10 to 100;
y is 1 to 20,
q is 5 to 40,
r is 2 to 50, and
Z is a capping group that is either hydrogen or a monovalent carbon radical of from 1 to 12 carbon atoms

29. The method of claim 16 wherein the silicone additive is a linear polyalkyleneoxide modified polydimethylsiloxane.

30. The method of claim 29 wherein the silicone additive is an (AB)ₙ polymer of the general formula:
—[—CₐH₂ₐ—(—Si(R⁷²)₂O—)—Si(R⁷²)₂—CₐH₂ₐ(OC₂H⁴) ᵢ(OC₃H₆)ₕ—]ₙ—
wherein:
each R⁷² is independently a monovalent hydrocarbon group of from 1 to 12 carbon atoms,
a is 2 to 4,
i is 5 to 30;
h is 3 to 10, and
n is 1 to 2
